(19) United States
(12) Patent Application Publication
(10) Pub. No.: US 2007/0090042 A1
(43) Pub. Date: Apr. 26, 2007

(54) Drainage assembly

(75) Inventor: Michael John Capper, Kellyville (AU)

Correspondence Address: NELSON MULLINS RILEY & SCARBOROUGH, LLP, 1320 MAIN STREET, 17TH FLOOR, COLUMBIA, SC, 29201, US

(73) Assignee: Cap Kay Corporation PTY Limited, Kellyville (AU)

(21) Appl. No.: 10/547,817

(22) PCT Filed: Mar. 4, 2004
(86) PCT No.: PCT/AU04/00276

§ 371 Date: Jun. 26, 2006

(30) Foreign Application Priority Data
Mar. 4, 2003 (AU) 2003900979

(51) Int. Cl. B01D 35/00

(52) U.S. Cl. 210/418; 210/499; 210/162

(57) ABSTRACT

A drainage assembly (10) comprising a cylindrical outer body (11) and cylindrical basket (12) have co-operating threads (13 and 14). a slotted flow though lid (15) is hinged at (16) to the body so that the lid (15) may be lifted to gain access to the basket (12). A centrally located cross bar (17) allows the basket to be rotated automaticall moved axially in the direction of the arrow (18) to remove the basket from the assembly and release a basket actuated valve member (19) biassed by biassing spring (20) to close off annular drainage opening (21) when the basket (12) is removed. A ball valve at (25) may be used to shut off flow through the assembly manually using a ball valve actuator (26) independently of the basket.

### FIELD OF THE INVENTION

THIS invention relates to a drainage assembly and in particular but not limited to a drainage assembly for reclamation of solids in waste water arising from a manufacturing process.

### BACKGROUND TO THE INVENTION

While the present invention has particular application to reclamation of valuable waste solids in commercial environments the present invention also has general application to removal of solids entrained in other waste liquids including general commercial and domestic waste water. In this sense the present invention has general application to drainage.

Some manufacturing processes involve production of waste water containing solids that if reclaimed could be dried and sold for profit. Removal of solids even if not for the purposes of resale is also a responsible environmental activity reducing downstream treatment costs. One e)xample is in the production of tobacco, reclamation of tobacco solids from run-off in this situation enables the reclaimed solids to be dried and sold.

In general, collection of solids flowing into a drain involves the use of some form of screen. In domestic situations this is most usually in the form of a removable perforated disc that simply fits in the sink drain inlet. The disc is removed and the accumulated solids disposed of. The disc is then returned.

This arrangement has disadvantages in so far as the screen can be discarded by the irresponsible user or, in the case of commercial reclamation using this principle, workers can choose not to replace the screen either intentionally or it can be inadvertently overlooked.

### OUTLINE OF THE INVENTION

An object of the present invention is to ameliorate this problem by providing in a broad form a drainage assembly having an inlet and an outlet, a removable screen able to contain solids entrained in waste liquid flowing through the assembly and a screen actuated valve blocking flow through the assembly when the screen is removed from the assembly.

In a preferred form the invention is provided by a drainage assembly having a body including an inlet, an outlet, a removable basket able to contain solids entrained in waste liquid flowing through the assembly and a basket actuated valve blocking flow through the assembly when the basket is removed from the assembly, the basket being positioned using an axially movable motion to position the basket in place, the axial motion also operating the basket actuated valve to open the valve as the basket is moved axially into the body to its operative screening position and when moved in the opposite direction axially out of the body the valve automatically closes, the basket actuated valve being biassed to a closed position by a biassing spring, the basket having a guide which cooperates with a guideway on the body so that the basket may be manually manipulated to engage the guide with the guideway and upon rotation moves axially into position thereby actuating the valve. Preferably the assembly includes a second downstream valve which may be used to block flow independently of the basket actuated valve.

Preferably the drainage assembly includes a shut off valve downstream of the screen actuated valve so that the flow may be blocked independently of the screen actuated valve. Preferably the shut off valve comprises a manually actuated ball valve built into the assembly.

Preferably the inlet comprises a hinged grill that may be lifted to gain access to the screen. Typically the removable screen comprises a perforated basket.

Typically the assembly includes an outer body which may be filtable into a sink, floor or any other drainage position where it is desirable to use such an assembly.

The screen or basket is typically located within the body and positioned using an axially movable motion to position the basket in place, the axial motion also operating the screen actuated valve to open the valve as the basket is moved axially into the body to its operative screening position and when moved in the opposite direction axially out of the body the valve closes.

The screen actuated valve is typically biassed to a closed position. An axially positioned biassing spring is typically utilised to provide bias force.

The basket typically includes a threaded top which cooperates with a threaded opening in the body, the basket having a bar across its top so that it may be manually manipulated to engage the thread and be screwed into position thereby actuating the valve.

### BRIEF DESCRIPTION OF THE DRAWING

In order that the present invention may be more readily understood and put into practical effect reference will now be made to the accompanying drawing wherein:

FIG. 1 is a section illustrating an embodiment of the invention as would be applied to a sink where it is desirable to shut off flow even when the basket is in position.

### METHOD OF PERFORMANCE

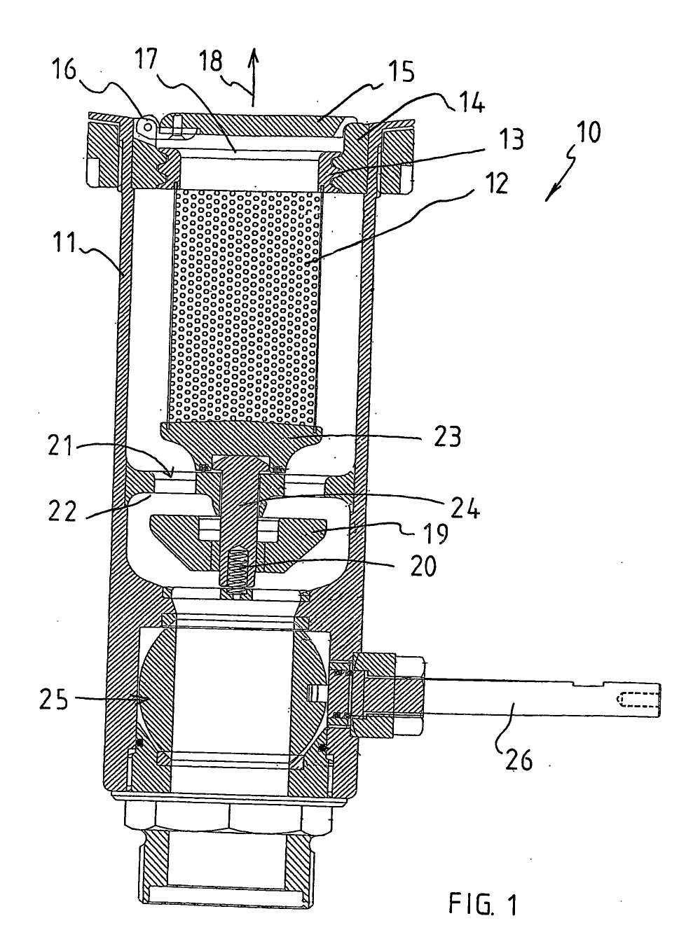

It will be appreciated that although the embodiment of FIG. 1 illustrates a shut off valve downstream of a basket in other drainage situations where it is not necessary to shut off flow when the basket is in position the downstream shut off valve would be omitted.

Referring to the drawing there is illustrated a drainage assembly 10 comprising a cylindrical outer body 11 holding a screen in the form of a cylindrical basket 12 which has a threaded upper section 13 which in turn engages a threaded insert 14 in the body 11. A slotted flow though lid 15 is hinged at 16 to the body so that the lid 15 may be lifted to gain access to the basket 12. A centrally located cross bar 17 allows the basket top portion 13 to be rotated and by reason of the threaded sections is automatically moved axially in the direction of the arrow 18 to remove the basket from the assembly.

A basket actuated valve member 19 is positioned below the basket and biassed by biassing spring 20 to close off annular drainage opening 21 when the basket 12 is removed. The valve member 19 is illustrated in FIG. 1 in its open position. A valve seat at 22 is engaged by the valve member 19 to close the opening 21. The basket 12 is mounted in a base 23 which locates over a spindle 24 housing spring 20.

A ball valve at 25 may be used to shut off the assembly manually using the ball valve actuator 26, the function of the ball valve would be equivalent to the operation of a plug should it be desirable to retain liquid in a sink during some soaking process or the like and then drain the sink. Such operations may apply to the use of caustic solutions where articles are soaked in the caustic solution and is undesirable for persons to place their hands in the solution.

It will be appreciated that where the assembly is utilised in say a floor drain, shower drain or similar there would generally be no requirement to utilise the ball valve.

Whilst the above has been given by way of illustrative example of the present invention many variations and modifications thereto will be apparent to those skilled in the art without departing from the broad ambit and scope of the invention as set out in the appended claims.

1. A drainage assembly comprising:
an inlet and an outlet;
a removable screen able to contain solids entrained in waste liquid flowing through the assembly; and
a screen actuated valve blocking flow through the assembly when the screen is removed from the assembly.

2. A drainage assembly according to claim 1 wherein the assembly comprises a second valve downstream of the screen actuated valve adapted to block flow independently of the screen actuated valve.

3. A drainage assembly according to claim 1 wherein the drainage assembly comprises a shut off valve downstream of the screen actuated valve and wherein the shut off valve comprises a manually actuated ball valve built into the assembly.

4. A drainage assembly according to claim 1 wherein the inlet comprises a hinged grill.

5. A drainage assembly according to claim 1 wherein the removable screen comprises a perforated basket.

6. A drainage assembly according to claim 1 wherein the assembly comprises an outer body adapted to be fit to a sink or a floor.

7. A drainage assembly according to claim 1 wherein the assembly comprises an outer body and the screen is located within the body and positioned using an axially movable motion to position the basket in place, the axial motion also operating the screen actuated valve to open the valve as the basket is moved axially into the body to its operative screening position and when moved in the opposite direction axially out of the body the valve closes.

8. A drainage assembly according to claim 1 wherein the screen actuated valve is biassed to a closed position.

9. A drainage assembly according to claim 1 wherein the screen actuated valve is biassed to a closed position by an axially positioned biassing spring adapted to provide a bias force.

10. A drainage assembly according to claim 1 wherein the assembly comprises an outer body and the screen comprises a basket comprising a threaded top cooperating with a threaded opening in the body, the basket comprising a bar adapted to be manually manipulated thereby engaging the thread and actuating the valve.

11. A drainage assembly comprising a body comprising an inlet, an outlet, a removable basket able to contain solids entrained in waste liquid flowing through the assembly and a basket actuated valve blocking flow through the assembly when the basket is removed from the assembly, the basket being positioned using an axially movable motion to position the basket in place, the axial motion also operating the basket actuated valve to open the valve as the basket is moved axially into the body to its operative screening position and when moved in the opposite direction axially out of the body the valve automatically closes, the basket actuated valve being biassed to a closed position by a biassing spring, the basket comprising a guide cooperating with a guideway on the body so that the basket may be manually manipulated to engage the guide with the guideway and upon rotation moves axially into position thereby actuating the valve.

12. A drainage assembly according to claim 11 wherein the assembly comprises a second valve downstream of the screen actuated valve operable to block flow independently of the screen actuated valve.

13. A drainage assembly according to claim 11 wherein the guide and guideway comprise co-operating threads.

14. A drainage assembly according to claim 11 wherein the assembly comprises a second valve downstream of the screen actuated valve operable to block flow independently of the screen actuated valve and the guide and guideway comprise co-operating threads.

15. A drainage assembly comprising:
a cylindrical outer body holding a cylindrical basket comprising a threaded upper section engaging a threaded insert in the body;
slotted flow through lid hinged to the body;
a centrally located cross bar; and
a basket actuated valve member positioned below the basket and biassed by a biassing spring thereby closing off an annular drainage opening when the basket is removed, and wherein a valve seat is engaged by the valve member to close the opening and the basket is mounted in a base located over a spindle housing the biassing spring.

16. A drainage assembly according to claim 15 comprising a ball valve located downstream of the basket actuated valve, the ball valve comprising a ball valve actuator operable to shut off flow.
